(19) United States
(12) Patent Application Publication
(10) Pub. No.: US 2024/0141687 A1
(43) Pub. Date: May 2, 2024

(54) DOOR AND DOOR HANDLE EXTENSION

(71) Applicant: The United States Government as represented by the Department of Veterans Affairs, Washington, DC (US)

(72) Inventors: Alexis Dang, San Francisco, CA (US); Alan Dang, San Francisco, CA (US); Cole Cuthbert, San Francisco, CA (US)

(21) Appl. No.: 18/278,954

(22) PCT Filed: Feb. 22, 2022
(86) PCT No.: PCT/US2022/017209

§ 371 Date: Aug. 25, 2023

Related U.S. Application Data
(60) Provisional application No. 63/153,496, filed on Feb. 25, 2021.

(51) Int. Cl. E05B 1/00

(52) U.S. Cl. CPC E05B 1/0069; E05B 1/0015

(57) ABSTRACT

A handle extension is mountable on a handle, such as a door handle, and provides the ability to open the door by using the forearm and thus not contacting the door with the hands to mitigate fomite transmission of pathogens. The handle extension uses receiver portions which mount on the handle. A horn extends from one of the receiver portions and provides an engagement surface to accommodate the forearm. Cinching straps are used to secure the handle extension to the handle.

### CROSS REFERENCE TO RELATED APPLICATIONS

This application is based upon and claims benefit of priority to U.S. Provisional Application No. 63/153,496, filed Feb. 25, 2021, the Provisional Application being hereby incorporated by reference herein.

### FIELD OF THE INVENTION

This invention relates to extensions for handles such as door handles to mitigate fomite transmission of pathogens.

### BACKGROUND

Inanimate objects (known as “fomites”) may serve as hosts for pathogens and act as a passive vector to infect humans who come into contact with the objects. Known fomites abound, and include everyday objects such as computer keyboards and accessories, telephones, writing instruments, flatware, countertops and handles to name but a few. Handles, in particular door handles, are an especially rich source for potential infection as they are typically made of non-porous material (which favors transmission of pathogens over porous material), are touched by many people in the course of a day, and not usually subject to a rigorous or effective sanitizing regimen. Pathogens from handles are transferred to the hands and fingers through simple contact, and then to the body through mucous membranes when the mouth, nose or eyes are touched. There is clearly an opportunity to mitigate fomite transmission from door handles.

### SUMMARY

The invention concerns a door and a handle extension mountable on a handle of the door. In an example embodiment the handle extension comprises a first receiver portion positionable on a first side of the handle. The first receiver portion defines a first void space configured to conform to a shape of at least a portion of the handle. A second receiver portion is positionable on a second side of the handle opposite to the first receiver portion. The second receiver portion defines a second void space configured to conform to the shape of the portion of the handle. An example embodiment may further comprise a horn extending from the first receiver portion. The horn projects transversely to the handle when the handle is received within the first and second void spaces.

By way of example, at least a first strap surrounds the first and second receiver portions to secure the handle extension to the handle. First grooves may be positioned in the first and second receiver portions in an example embodiment. The first grooves receive the first strap. An example embodiment may further comprise at least a second strap surrounding the first and second receiver portions to secure the handle extension to the handle. In a specific example, second grooves may be positioned in the first and second receiver portions. The second grooves receive the second strap.

By way of example, the first and second straps may comprise cinching straps. In another example, the first and second void spaces may comprise respective first and second channels. Each first and second channel may have first and second legs angularly oriented with respect to one another.

In an example embodiment, both the receiver portions and the horn are formed from bio-compostable plastic or carbon fiber reinforced nylon.

### BRIEF DESCRIPTION OF THE DRAWINGS

FIG. 1 is an isometric view of an example door handle extension according to the invention, installed on a door;

FIG. 2 is an isometric exploded view of the door handle extension shown in FIG. 1;

FIG. 3 is an isometric exploded view of the door handle extension shown in FIG. 1; and

FIG. 4 is a bottom plan view of the door handle extension shown in FIG. 1.

### DETAILED DESCRIPTION

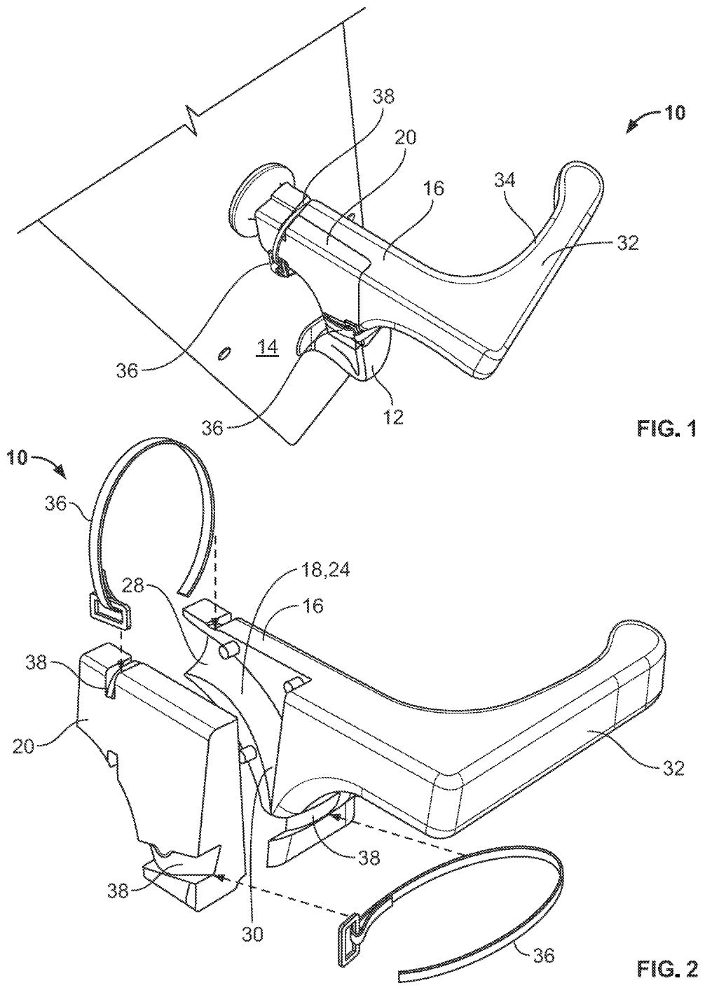

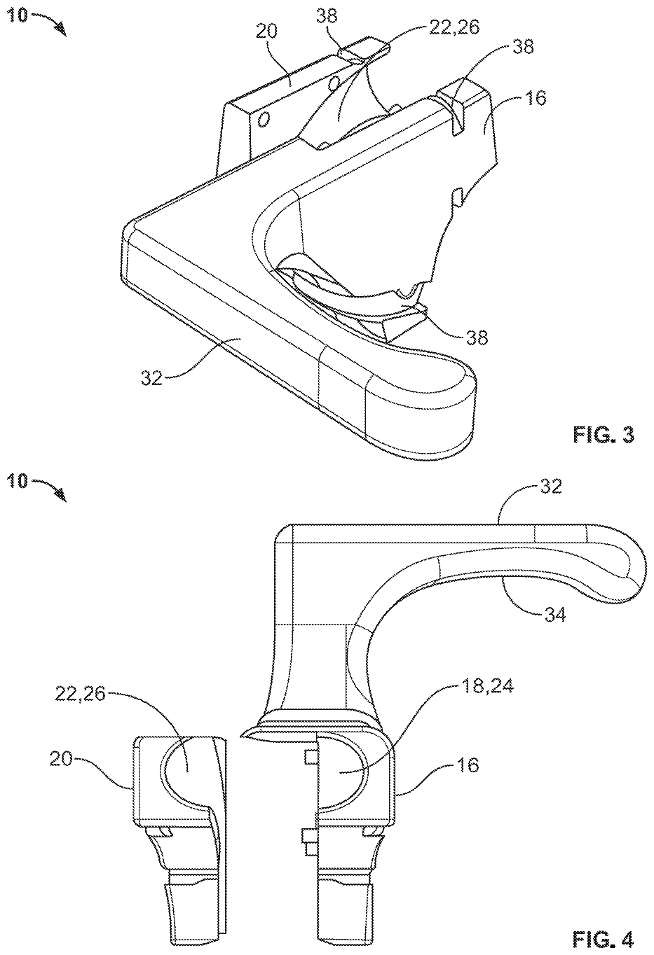

FIG. 1 shows an example handle extension 10 mountable on a handle 12. In this example the handle 12 is mounted on a door 14. As shown in FIG. 2, example handle extension 10 comprises a first receiver portion 16 positionable on a first side of the handle 12. The first receiver portion 16 defines a first void space 18 which is configured to conform to the shape of at least a portion of the handle 12. A second receiver portion 20 is positionable on a second side of the handle 12 opposite to the first receiver portion 16 as shown in the exploded view. As shown in FIGS. 3 and 4, the second receiver portion 20 defines a second void space 22 also configured to conform to the shape of the same portion of the handle 12 as the first void space 18.

It is advantageous if the portion of the handle 12 which is received by the void spaces 18 and 22 has segments which are angularly oriented with respect to one another, for example, at a bend of the handle. Mounting the handle extension 10 at such a bend or similar structure provides positive mechanical engagement between the handle 12 and the handle extension 10 and prevents the handle extension 10 from rotating relatively to the handle when force is applied to open the door 14. To that end, in the example embodiment shown in FIGS. 2-4, the first and second void spaces 18 and 22 comprise respective first and second channels 24 and 26. Each channel has a first leg 28 and a second leg 30. Legs 28 and 30 are angularly oriented with respect to one another to accommodate the bend in handle 12.

As further shown in FIGS. 2 and 3, a horn 32 extends from the first receiver portion 16 of the handle extension 10. Horn 32 projects transversely to the handle 12 when the handle is received within the first and second void spaces 18 and 22 as shown in FIG. 1. Horn 32 defines an engagement surface 34 (see also FIG. 4) between itself and the door 14 which is sized to receive the forearm, allowing a person to open the door without touching the handle 12 or the handle extension 10 with the fingers of a hand. Engagement surface 34 is ergonomically designed to have a shape that is comfortable to a user on a part of the arm which is not normally used to apply force, and is therefore sensitive to pressure.

It is advantageous to secure handle extension 10 to the handle 12 in a manner which will allow convenient mounting and dismounting of the assembly while withstanding the applied force needed to open even heavy industrial and fire resistant doors. As shown in FIG. 1, a secure mounting of handle extension 10 to handle 12 in this example is accomplished using one or more straps 36 (in this example embodiment, first and second straps 36a and 36b) to respectively surround the first and second receiver portions 16 and 20 to cinch the receiver portions to one another surrounding the handle 12. Cinching straps, commonly known as “cable ties” or “zip ties” are particularly effective in this role as they have been shown to provide adequate cinching force to maintain the receiver portions 16 and 20 securely in place on handle 12 under the applied loads necessary to open the door. Furthermore, the use of cinching straps requires no tools for installation and allow for quick removal using shears to cut the ties should the handle extension need to be removed. As shown in FIGS. 1 and 2, it is advantageous to provide grooves 38 in the outer surfaces of the first and second receiver portions 16 and 20 to accommodate the cinching straps 36 and prevent them from shifting under loads imposed on the handle extension during use. In this example embodiment, first and second grooves 38a and 38b respectively receive the first and second cinching straps 36a and 36b.

While the handle extension 10 may be formed from a number of different materials, synthetic materials are advantageous for their relative stiffness, strength and light weight. Synthetic materials are also selected for their resistance to chemical attack, allowing them to be repeatedly sanitized by even some of the more aggressive antimicrobial solutions. Practical handle extension designs have been formed from bio-compostable plastic, and it is foreseen that carbon-fiber reinforced nylon would also be practical when greater strength is needed.

What is claimed is:

1. A handle extension mountable on a handle, said handle extension comprising:
a first receiver portion positionable on a first side of said handle, said first receiver portion defining a first void space configured to conform to a shape of at least a portion of said handle;
a second receiver portion positionable on a second side of said handle opposite to said first receiver portion, said second receiver portion defining a second void space configured to conform to said shape of said portion of said handle.

2. The handle extension according to claim 1, further comprising a horn extending from said first receiver portion, said horn projecting transversely to said handle when said handle is received within said first and second void spaces.

3. The handle extension according to claim 1, further comprising at least a first strap surrounding said first and second receiver portions to secure said handle extension to said handle.

4. The handle extension according to claim 3, further comprising first grooves positioned in said first and second receiver portions, said first grooves receiving said first strap.

5. The handle extension according to claim 4, further comprising at least a second strap surrounding said first and second receiver portions to secure said handle extension to said handle.

6. The handle extension according to claim 5, further comprising second grooves positioned in said first and second receiver portions, said second grooves receiving said second strap.

7. The handle extension according to claim 3, wherein said first strap comprises a cinching strap.

8. The handle extension according to claim 5, wherein said second strap comprises a cinching strap.

9. The handle extension according to claim 1, wherein said first and second void spaces comprise respective first and second channels, each said first and second channel having first and second legs angularly oriented with respect to one another.

10. The handle extension according to claim 2, wherein said receiver portions and said horn are formed from bio-compostable plastic or carbon fiber reinforced nylon.

11. A door comprising a handle and a handle extension mounted thereon, said handle extension comprising:
a first receiver portion positioned on a first side of said handle, said first receiver portion defining a first void space configured to conform to a shape of at least a portion of said handle;
a second receiver portion positioned on a second side of said handle opposite to said first receiver portion, said second receiver portion defining a second void space configured to conform to said shape of said portion of said handle.

12. The door according to claim 11, further comprising a horn extending from said first receiver portion, said horn projecting transversely to said handle when said handle is received within said first and second void spaces.

13. The door according to claim 11, further comprising at least a first strap surrounding said first and second receiver portions to secure said handle extension to said handle.

14. The door according to claim 13, further comprising first grooves positioned in said first and second receiver portions, said first grooves receiving said first strap.

15. The door according to claim 14, further comprising at least a second strap surrounding said first and second receiver portions to secure said handle extension to said handle.

16. The door according to claim 15, further comprising second grooves positioned in said first and second receiver portions, said second grooves receiving said second strap.

17. The door according to claim 13, wherein said first strap comprises a cinching strap.

18. The door according to claim 15, wherein said second strap comprises a cinching strap.

19. The door according to claim 11, wherein said first and second void spaces comprise respective first and second channels, each said first and second channel having first and second legs angularly oriented with respect to one another.

20. The door according to claim 12, wherein said receiver portions and said horn are formed from bio-compostable plastic or carbon fiber reinforced nylon.
